(19) United States
(12) Patent Application Publication
(10) Pub. No.: US 2017/0323008 A1
(43) Pub. Date: Nov. 9, 2017

(54) COMPUTER-IMPLEMENTED METHOD, SEARCH PROCESSING DEVICE, AND NON-TRANSITORY COMPUTER-READABLE STORAGE MEDIUM

(71) Applicant: FUJITSU LIMITED, Kawasaki-shi (JP)

(72) Inventor: Takuya Makino, Kawasaki (JP)

(73) Assignee: FUJITSU LIMITED, Kawasaki-shi (JP)

(21) Appl. No.: 15/587,353

(22) Filed: May 4, 2017

(30) Foreign Application Priority Data
May 9, 2016 (JP) 2016-093659

(51) Int. Cl. G06F 17/30

(52) U.S. Cl. CPC G06F 17/30654; G06F 17/30707; G06F 17/30687; G06F 17/30696

(57) ABSTRACT

A computer-implemented method for creating and searching a database, the method including, storing inquiry data within a database, dividing the inquiry data into sentences to generate sentence data, segmenting the sentence data to obtain word string data, identifying a plurality of content words within with the word string data, calculating a first probability for each of the plurality of content words, the first probability indicating a probability of a first word being adjacent to a second word, receiving an instruction including at least one word string, selecting a first extended keyword having a highest probability of being adjacent to the word string, extracting a second extended keyword having a lower probability than the first content word of being adjacent to the word string, searching the database based on a word string, first extended keyword and second extended keyword.

### CROSS-REFERENCE TO RELATED APPLICATION

This application is based upon and claims the benefit of priority of the prior Japanese Patent Application No. 2016-093659, filed on May 9, 2016, the entire contents of which are incorporated herein by reference.

### FIELD

The embodiments discussed herein are related to a search processing technique.

### BACKGROUND

In a call center or the like, a search system of a collection of question and answer (Q&A) may be used in order to respond to inquiries from customers. An operator who uses the search system may carry out entry operation (for example, keyboard typing) of a character string based on what is spoken by the customer to thereby cause the search system to execute a search and present a correct Q&A.

However, in some cases, the correct Q&A may not be presented.

Related art is disclosed in Japanese Laid-open Patent Publications No. 2007-157006, No. 2014-120053, No. 2006-39881, No. 2014-134871, and No. 2012-242966.

Related art is further disclosed in Steffen Bickel, Peter Haider, and Tobias Scheffer, “Learning to Complete Sentences,” European Conference on Machine Learning, 2005, pp. 497-504 (Non-Patent Document 1).

### SUMMARY

According to an aspect of the embodiments, a computer-implemented method for creating and searching a database, the method including, storing inquiry data within a database, the inquiry data including a plurality of questions and related answers, each of the questions and answers including one or more words, dividing the inquiry data into sentences to generate sentence data, segmenting the sentence data to obtain word string data, identifying a plurality of content words within with the word string data, the plurality of content words including a first word and a second word, counting a number of times each of the plurality of content words are included within the word string data, calculating a first probability for each of the plurality of content words, the first probability indicating a probability of the first word being adjacent to the second word, receiving an instruction including at least one word string, selecting a first extended keyword from the database based on the first probability for each of the content words, the first extended keyword including a word string from the instruction and a first content word having a highest probability of being adjacent to the word string, extracting a second extended keyword from the database based on the first probability for each of the content words, the second extended keyword having a second content word having a lower probability than the first content word of being adjacent to the word string, searching the database based on a word string, first extended keyword and second extended keyword, and outputting candidate questions or answers from the inquiry data as search results obtained from the database.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram for explaining entry of a character string and display of a search result;

FIG. 2A is a functional block diagram of a search processing device;

FIG. 2B is a functional block diagram of a search processing unit;

FIG. 3 is a diagram representing one example of data stored in an inquiry data storing unit;

FIG. 4 is a diagram representing one example of data stored in a Q&A data storing unit;

FIG. 5 is a diagram representing a processing flow of processing executed by a first calculating unit;

FIG. 6 is a diagram representing one example of data of inquiries stored in an inquiry data storing unit;

FIG. 7 is a diagram representing one example of data stored in a sentence data storing unit;

FIG. 8 is a diagram representing one example of data stored in a word string data storing unit;

FIGS. 9A and 9B are diagrams representing one example of cnt(w) and one example of cnt(u, w);

FIG. 10 is a diagram representing one example of data stored in a probability data storing unit;

FIG. 11 is a diagram representing a processing flow of processing executed by a second calculating unit after execution of processing by a first calculating unit;

FIG. 12 is a diagram representing one example of data stored in a probability distribution data storing unit;

FIG. 13 is a diagram representing one example of data stored in a keyword storing unit;

FIG. 14 is a diagram representing a processing flow of processing executed by a search processing unit;

FIGS. 15A to 15C are diagrams representing one example of extracted extended keywords;

FIG. 16 is a diagram for explaining a language model;

FIG. 17 is a diagram illustrating an outline of a system of a second embodiment; and

FIG. 18 is a functional block diagram of a computer.

### DESCRIPTION OF EMBODIMENTS

In one aspect, the embodiments discussed herein intend to provide a technique for extracting a proper Q&A based on an entered character string.

### Embodiment 1

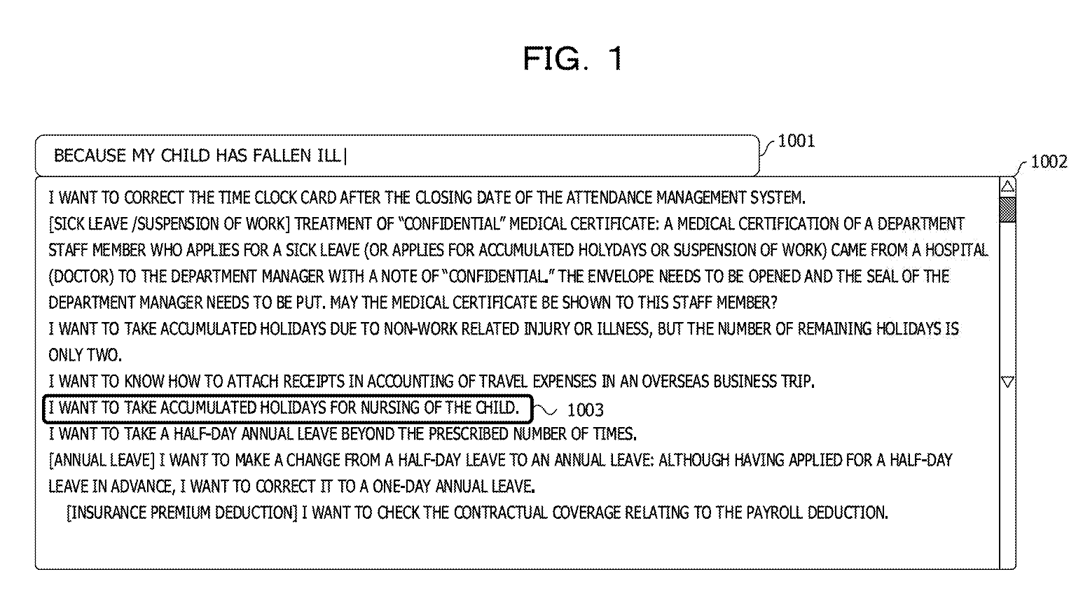

In the case of carrying out a search based on an entered character string, when the number of characters included in the character string becomes larger, clues to the search increase and thus the possibility that a correct Q&A is extracted becomes higher, but the burden on the user becomes larger. For example, as illustrated in FIG. 1, it is preferable that a correct Q&A (in FIG. 1, part surrounded by a thick frame 1003) be displayed in a display field 1002 of the search result at the stage when part of a character string intended to be entered by a user is entered into an entry field 1001.

Furthermore, as in the example of FIG. 1, it is preferable that the correct Q&A be extracted even when the entered character string is not included in the sentence of the correct Q&A. However, if a method of carrying out a search by using only the entered character string as a clue is used, the correct Q&A in the example of FIG. 1 is not displayed and Q&As that are not correct are displayed. Moreover, also in the case of carrying out a search with use of a character string that tends to appear with the entered character string, the search result does not necessarily include a wide variety of Q&As and the correct Q&A is not displayed in some cases.

Therefore, in the present embodiment, search processing is executed by the following method.

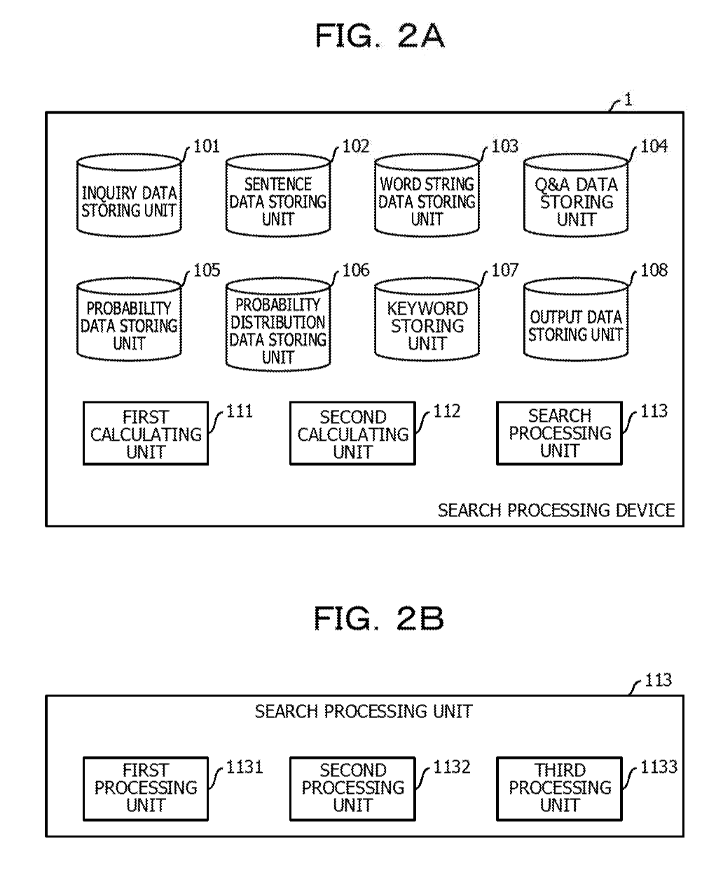

In FIG. 2A, a functional block diagram of a search processing device 1 in the present embodiment is illustrated. The search processing device 1 includes an inquiry data storing unit 101, a sentence data storing unit 102, a word string data storing unit 103, a Q&A data storing unit 104, a probability data storing unit 105, a probability distribution data storing unit 106, a keyword storing unit 107, an output data storing unit 108, a first calculating unit 111, a second calculating unit 112, and a search processing unit 113. In FIG. 2B, a functional block diagram of the search processing unit 113 is illustrated. The search processing unit 113 includes a first processing unit 1131, a second processing unit 1132, and a third processing unit 1133.

The first calculating unit 111 executes processing based on data stored in the inquiry data storing unit 101 and stores the processing result in the sentence data storing unit 102, the word string data storing unit 103, and the probability data storing unit 105. The second calculating unit 112 executes processing based on data stored in the word string data storing unit 103, data stored in the Q&A data storing unit 104, and data stored in the probability data storing unit 105 and stores the processing result in the probability distribution data storing unit 106 and the keyword storing unit 107. The search processing unit 113 executes processing based on data stored in the probability data storing unit 105, data stored in the probability distribution data storing unit 106, and data stored in the keyword storing unit 107 and stores the processing result in the output data storing unit 108. For example, the first processing unit 1131 executes processing of extracting the extended keyword added first among extended keywords. The second processing unit 1132 executes processing of extracting the extended keywords added second or later among the extended keywords. The third processing unit 1133 carries out a search based on an entered character string and the extended keywords.

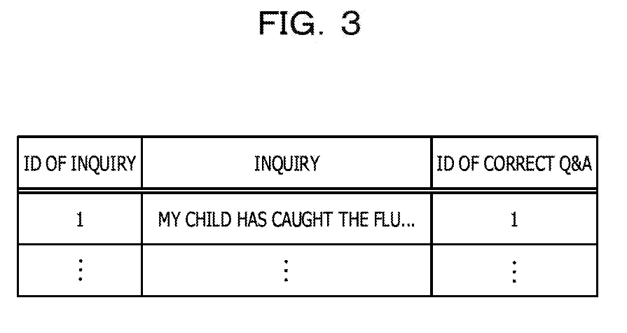

In FIG. 3, one example of data stored in the inquiry data storing unit 101 is represented. In the example of FIG. 3, the identifiers (IDs) of inquiries, data of natural languages relating to the inquiries, and the IDs of Q&As that are proper as correct answers to the inquiries (for example, Q&As that are proper as responses presented regarding the inquiries) are stored. The data of inquiries stored in the inquiry data storing unit 101 is data of inquiries that were actually accepted in the past.

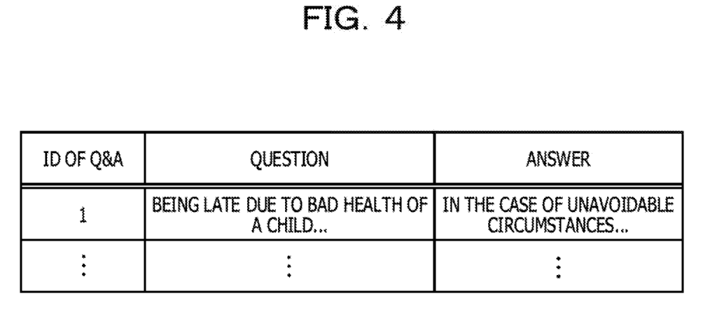

In FIG. 4, one example of data stored in the Q&A data storing unit 104 is represented. In the example of FIG. 4, the ID of Q&As, data of questions, and data of answers are stored. The data of questions and the data of answers stored in the Q&A data storing unit 104 is data entered as models of Q&A by an administrator or the like (for example, data of frequently asked questions (FAQs)).

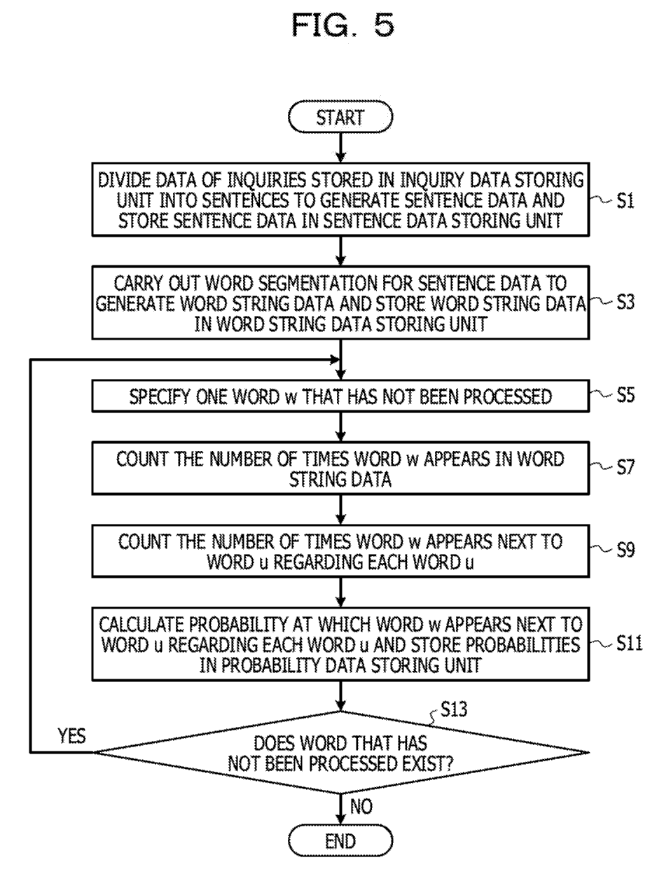

Next, the operation of the search processing device 1 will be described by using FIG. 5 to FIG. 16.

First, processing executed by the first calculating unit 111 will be described by using FIG. 5 to FIG. 10. The first calculating unit 111 of the search processing device 1 divides the data of inquiries stored in the inquiry data storing unit 101 into units of sentences to generate sentence data. Then, the first calculating unit 111 stores the generated sentence data in the sentence data storing unit 102 (FIG. 5: step S1).

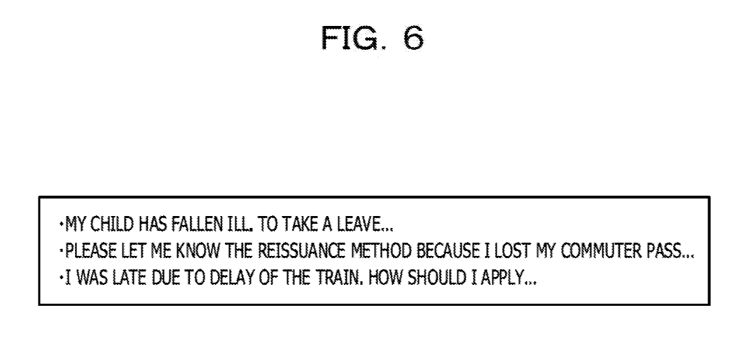

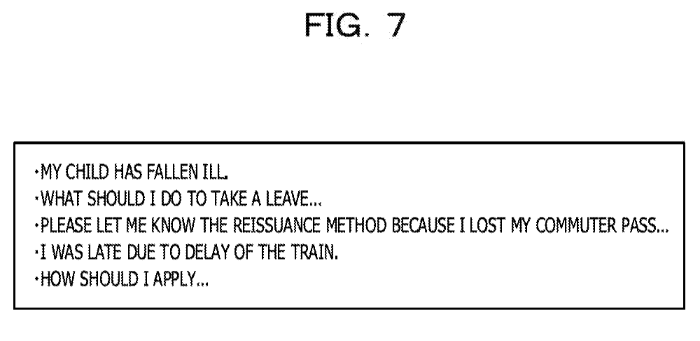

In FIG. 6, one example of the data of inquiries stored in the inquiry data storing unit 101 is represented. The data of inquiries includes data of one or plural sentences in each inquiry. By the processing of the step S1, as represented in FIG. 7, for example, sentence data is generated about each sentence and is stored in the sentence data storing unit 102.

The first calculating unit 111 carries out word segmentation (referred to also as part-of-speech decomposition) for the sentence data stored in the sentence data storing unit 102 to generate word string data. Then, the first calculating unit 111 stores the generated word string data in the word string data storing unit 103 (step S3).

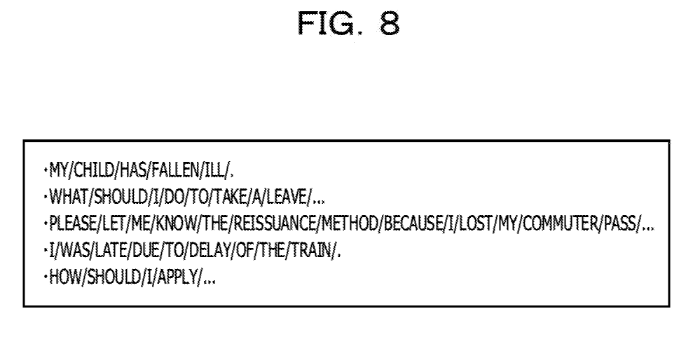

In FIG. 8, one example of the data stored in the word string data storing unit 103 is represented. In the example of FIG. 8, the sentence data is segmented into units of words but the order of appearance of the words is kept.

The first calculating unit 111 specifies one word that has not been processed among the words stored in the word string data storing unit 103 (step S5). The word specified in the step S5 is defined as w.

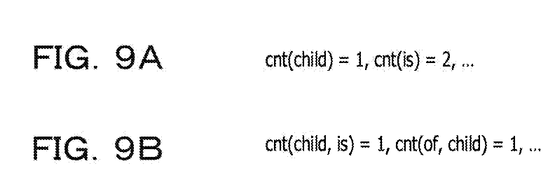

The first calculating unit 111 counts the number of times the word w specified in the step S5 appears in the word string data stored in the word string data storing unit 103 (step S7). The number of times counted in the step S7 is defined as cnt(w). In FIG. 9A, one example of cnt(w) counted in the step S7 is represented.

The first calculating unit 111 counts the number of times the word w appears next to a word u in the word string data stored in the word string data storing unit 103 regarding each word u (step S9). The number of times counted in the step S9 is defined as cnt(u, w). In FIG. 9B, one example of cnt(u, w) counted in the step S9 is represented.

The first calculating unit 111 calculates the probability at which the word w appears next to the word u regarding each word u and stores the calculated probabilities in the probability data storing unit 105 (step S11). In the step S11, the probability is calculated regarding each word u in accordance with the following expression.

$$P ( w \vert u ) = \frac{cnt ( u , w )}{cnt ( w )} \qquad [ Expression 1 ]$$

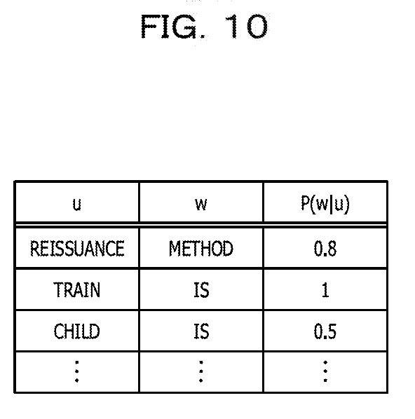

In FIG. 10, one example of the data stored in the probability data storing unit 105 is presented. In the example of FIG. 10, P(w|u) is stored for each of the combinations of the word u and the word w.

The first calculating unit 111 determines whether a word that has not been processed exists (step S13). If a word that has not been processed exists (step S13: Yes route), the first calculating unit 111 returns to the processing of the step S5. On the other hand, if a word that has not been processed does not exist (step S13: No route), the processing ends.

If the above processing is executed, the probabilities of appearance of word strings are calculated in advance and therefore it becomes possible to suppress the time taken to carry out a search from becoming long.

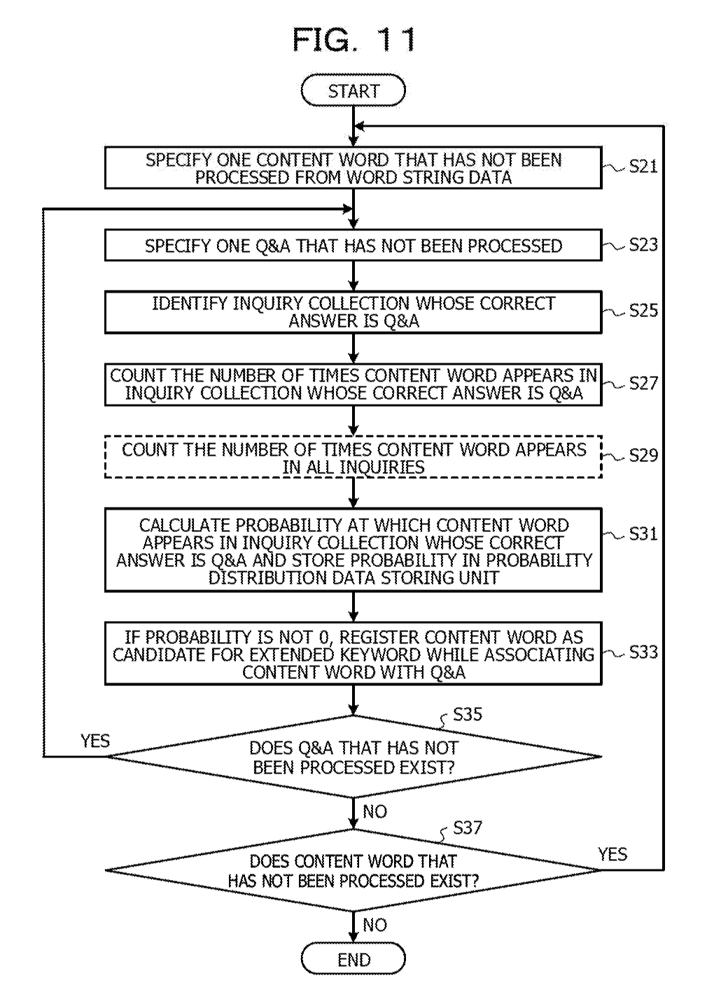

Next, processing executed by the second calculating unit 112 after the execution of the processing by the first calculating unit 111 will be described by using FIG. 11 to FIG. 13.

First, the second calculating unit 112 specifies one content word (noun, verb, adjective, and so forth) that has not been processed from the word string data stored in the word string data storing unit 103 (FIG. 11: step S21). The content word specified in the step S21 will be referred to as the content word of the processing target.

The second calculating unit 112 specifies one ID of a Q&A that has not been processed among the Q&As whose IDs are stored in the Q&A data storing unit 104 (step S23).

The second calculating unit 112 identifies an inquiry collection corresponding to the ID of the Q&A specified in the step S23 (for example, collection of inquiries whose correct answer is the Q&A specified in the step S23) from the inquiry data storing unit 101 (step S25).

The second calculating unit 112 counts the number of times the content word of the processing target appears in the inquiry collection whose correct answer is the Q&A specified in the step S23 (step S27).

The second calculating unit 112 counts the number of times the content word of the processing target appears in all inquiries whose IDs are stored in the inquiry data storing unit 101 (step S29). The processing of the step S29 may be omitted if the processing of the step S29 has been already executed. Thus, the block of the step S29 is represented by a dashed line in FIG. 11.

The second calculating unit 112 calculates the probability at which the content word of the processing target appears in the inquiry collection whose correct answer is the Q&A specified in the step S23, and stores the calculated probability in the probability distribution data storing unit 106 (step S31).

In the step S31, the calculation is performed in accordance with the following expression.

$${P}_{i} ( w ) = \frac{cnt ( w , {F}_{i} )}{{\sum }_{k} cnt ( w , {F}_{k} )} \qquad [ Expression 2 ]$$

Here, i is a variable that represents the ID of a Q&A and w is the content word specified in the step S21. cnt(w, Fᵢ) is the number of times the content word w appears in the inquiry collection whose correct answer is the Q&A whose identifier is i, and Σₖcnt(w, Fₖ) represents the number of times the content word w appears in all inquiries.

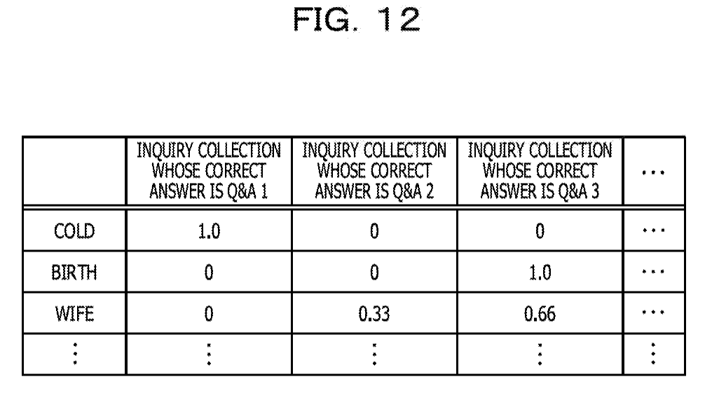

In FIG. 12, one example of the data stored in the probability distribution data storing unit 106 is represented. In the example of FIG. 12, regarding each content word, the probabilities at which the content word appears in inquiry collections whose correct answers are the respective Q&As are stored.

If the probability calculated in the step S31 is not 0, the second calculating unit 112 registers the content word of the processing target in the keyword storing unit 107 as a candidate for an extended keyword while associating the content word with the ID of the Q&A (step S33).

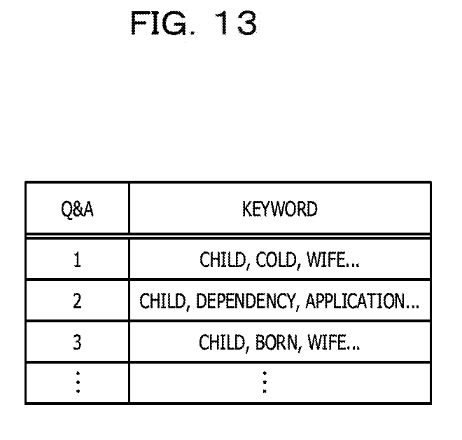

In FIG. 13, one example of the data stored in the keyword storing unit 107 is represented. In the example of FIG. 13, the identifiers of Q&A and keywords about which the probability of appearance in the inquiry collection whose correct answer is the Q&A is not 0 are stored.

The second calculating unit 112 determines whether a Q&A that has not been processed exists (step S35). If a Q&A that has not been processed exists (step S35: Yes route), the second calculating unit 112 returns to the processing of the step S23.

On the other hand, if a Q&A that has not been processed does not exist (step S35: No route), the second calculating unit 112 determines whether a content word that has not been processed exists (step S37).

If a content word that has not been processed exists (step S37: Yes route), the second calculating unit 112 returns to the processing of the step S21. If a content word that has not been processed does not exist (step S37: No route), the processing ends.

If the above processing is executed, the probability at which each content word appears in each inquiry collection (here, inquiry collection whose correct answer is the same Q&A) is calculated in advance and thus it becomes possible to suppress the time taken to carry out a search from becoming long.

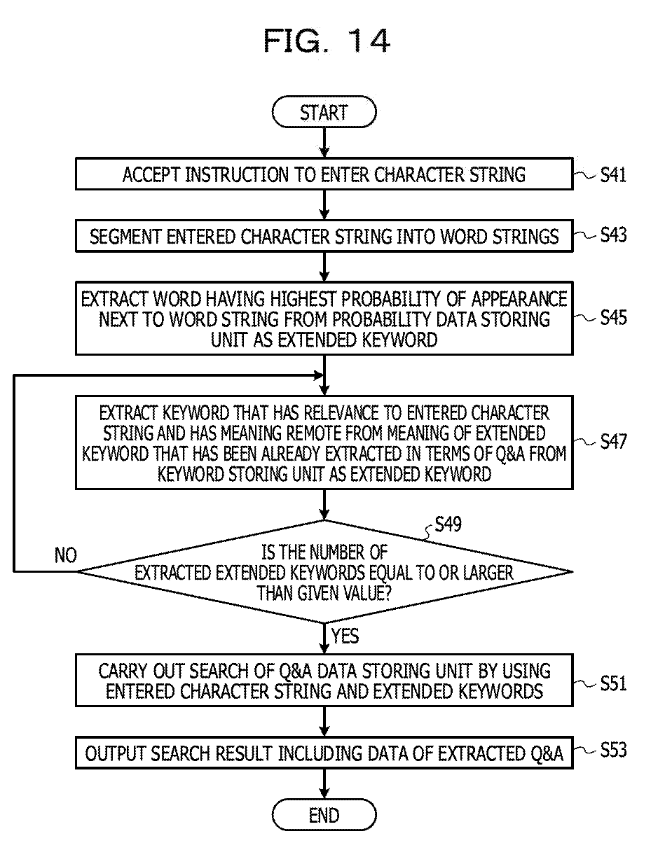

Next, processing executed by the search processing unit 113 will be described by using FIG. 14 to FIG. 16.

First, the search processing unit 113 accepts an instruction to enter a character string from an operator of the search processing device 1 (FIG. 14: step S41). The character string in the step S41 is equivalent to the character string in the scope of claims, for example.

The search processing unit 113 segments the entered character string into word strings (step S43).

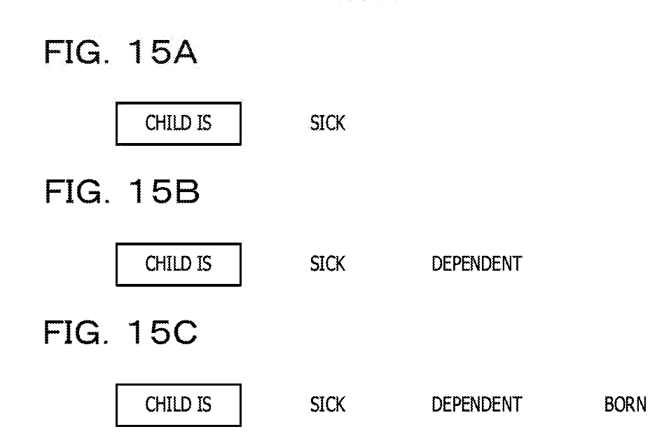

The first processing unit 1131 in the search processing unit 113 extracts the word having the highest probability of appearance next to the word string generated from the entered character string from the probability data storing unit 105 as an extended keyword (step S45). For example, if a character string of “child is” is entered, the character string is segmented into a word string of “child/is.” Therefore, the probability at which a certain word appears next to “child is” may be obtained based on the probability at which “is” appears next to “child” and the probability at which the certain word appears next to “is.” Here, suppose that a word of “sick” is extracted as represented in FIG. 15A. The word identified in the step S45 is equivalent to the first word in the scope of claims, for example.

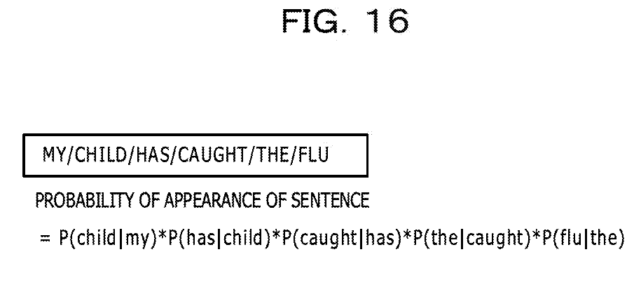

A language model in which the goodness of linkage of word strings is calculated is known and the technique thereof may be utilized also for the calculation in the processing of the step S45. For example, as represented in FIG. 16, if a sentence of “my child has caught the flu” is entered, the entered sentence may be segmented into word strings of “my/child/has/caught/the/flu.” Here, the probability of appearance of the sentence of “my child has caught the flu” is calculated based on P(child|my)*P(has|child)*P(caught|has)*P(the|caught)*P(flu|the). Regarding such a language mode, Non-Patent Document 1 also includes a description.

The second processing unit 1132 in the search processing unit 113 extracts a word that has relevance to the entered character string and has a meaning remote from the meaning of the extended keyword that has been already extracted in terms of the Q&A from the keyword storing unit 107 as an extended keyword (step S47). The word identified in the step S47 is equivalent to the second word in the scope of claims, for example.

In the step S47, the keyword is extracted based on the following expression.

arg max_{w}_{ᵢ}_{εV\S}λsim₁(wᵢ,Q)−(1−λ)max_{q}_{ⱼ}_{εs}sim₂(wᵢ,qⱼ) [Expression 3]

Here, Q is word strings t1, t2, . . . generated from an entered character string. V is a set of candidates for extended keywords. wᵢ is a candidate for an extended keyword included in V. S is a set of extended keywords selected by the calculation timing. qⱼ is an extended keyword included in S. λ is a hyperparameter.

sim₁(wᵢ, Q) of the first term is represented as follows.

sim₁(wᵢ,Q)=P(wᵢ|Q)=P(wᵢ|t₁,t₂, . . . ) [Expression 4]

The first term represents the goodness of linkage with the word strings t1, t2, . . . (for example, how high the probability of appearance next to the word strings t1, t2, . . . is).

sim₂(wᵢ, qⱼ) of the second term is represented as follows.

$${sim}_{2} ( {w}_{i} , {q}_{j} ) = {\{ {\sum }_{k} {P}_{k} ( {w}_{i} ) log \frac{{P}_{k} ( {w}_{i} )}{{P}_{k} ( {q}_{j} )} \}}^{- 1} \qquad [ Expression 5 ]$$

The second term represents the closeness of the word meaning to an extended keyword that has been already selected in terms of the Q&A. The value of the second term becomes smaller when the ratio Pₖ(w)/Pₖ(qⱼ) of the probability of appearance is higher. For example, the value of the second term becomes smaller when the probability of appearance of wᵢ in a certain inquiry collection is higher and the probability of appearance of qⱼ in the certain inquiry collection is lower. Furthermore, the value of the second term becomes smaller also when the probability of appearance of wᵢ in a certain inquiry collection is lower and the probability of appearance of qⱼ in the certain inquiry collection is higher.

For example, as represented in an example of FIG. 15B, if a character string of “child is” is entered and an extended keyword of “sick” has been already selected, “dependent,” whose probability of appearance next to “child is” is comparatively high and whose meaning is not close to that of “sick” in terms of the Q&A, is selected.

Furthermore, for example, as represented in an example of FIG. 15C, if a character string of “child is” is entered and an extended keyword of “sick” has been already selected and an extended keyword of “dependent” has been already selected, “born,” whose probability of appearance next to “child is” is comparatively high and whose meaning is not close to that of “sick” in terms of the Q&A, is selected.

The search processing unit 113 determines whether the number of extended keywords extracted in the steps S45 and S47 is equal to or larger than a given value (step S49). If the number of extended keywords extracted in the steps S45 and S47 is not equal to or larger than the given value (step S49: No route), the search processing unit 113 returns to the processing of the step S47.

On the other hand, if the number of extended keywords extracted in the steps S45 and S47 is equal to or larger than the given value (step S49: Yes route), the third processing unit 1133 in the search processing unit 113 carries out a search of the Q&A data storing unit 104 by using the entered character string and the extracted extended keywords (step S51). For example, the search is carried out based on a search expression like (entered character string) AND (extended keyword OR extended keyword OR . . . OR extended keyword).

The search processing unit 113 generates data of the search result including data of the Q&A extracted by the search and stores the data of the search result in the output data storing unit 108. Then, the search processing unit 113 outputs the data of the search result stored in the output data storing unit 108 (step S53). For example, the search processing unit 113 causes a display device of the search processing device 1 to display the data of the search result. Then, the processing ends.

If the above processing is executed, a search based on extended keywords identified from a wide variety of perspectives is carried out and thus it becomes possible to avoid extraction of the search result with biased perspectives.

Furthermore, because the probability of appearance next to an entered character string is used, it becomes possible to extract extended keywords having relevance to the entered character string and extraction of the correct Q&A is facilitated.

Moreover, it becomes possible to reduce the burden of entry operation such as keyboard typing.

### Embodiment 2

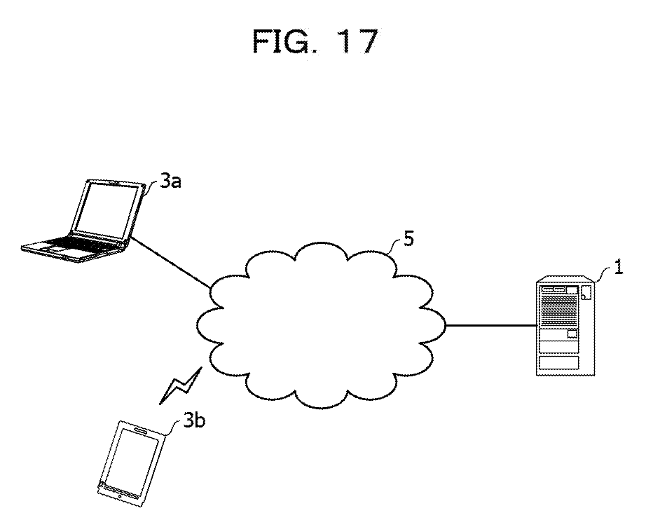

In FIG. 17, the outline of a system in a second embodiment is illustrated. In the second embodiment, the search processing device 1 and user terminals 3a and 3b are coupled to a network 5 such as the Internet. Although the number of user terminals is two in FIG. 17, there is no limit to the number.

The user terminals 3a and 3b accept an instruction to enter a character string from a user and transmit the entered character string to the search processing device 1. The search processing device 1 carries out a search based on the received character string and transmits the search result to the user terminals 3a and 3b.

This configuration allows the user who does not directly operate the search processing device 1 to utilize the search for Q&A data by the search processing device 1.

Although the embodiments are described above, techniques of the present disclosure are not limited thereto. For example, the functional block configuration of the search processing device 1 described above does not correspond with the actual program module configuration in some cases.

Furthermore, the configurations of the respective tables described above are one example and do not have to be the above-described configurations. Moreover, also in the processing flows, it is also possible to change the order of processing if the processing result does not vary. In addition, plural kinds of processing may be executed in parallel.

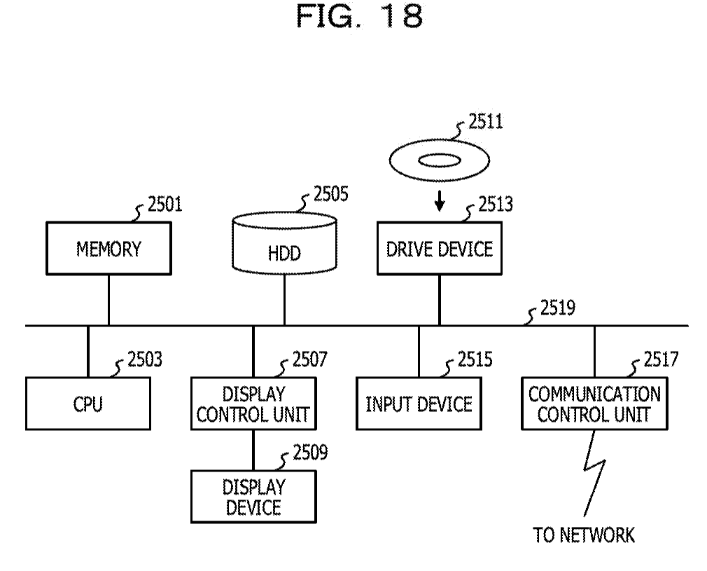

The search processing device 1 described above is a computer device. As illustrated in FIG. 18, a memory 2501, a central processing unit (CPU) 2503, a hard disk drive (HDD) 2505, a display control unit 2507 coupled to a display device 2509, a drive device 2513 for a removable disc 2511, an input device 2515, and a communication control unit 2517 for coupling to a network are coupled by a bus 2519. An operating system (OS) and application programs for executing the processing in the embodiments are stored in the HDD 2505 and are read out from the HDD 2505 to the memory 2501 when being executed by the CPU 2503. The CPU 2503 controls the display control unit 2507, the communication control unit 2517, and the drive device 2513 according to the contents of processing of the application program and causes given operation to be carried out. Furthermore, data in the middle of processing is stored mainly in the memory 2501 but may be stored in the HDD 2505. In the embodiments, the application programs for executing the processing described above are stored in the computer-readable removable disc 2511 and are distributed to be installed on the HDD 2505 from the drive device 2513. In some cases, the application programs are installed on the HDD 2505 via a network such as the Internet and the communication control unit 2517. Such a computer device implements the various kinds of functions described above through organic cooperation between hardware such as the CPU 2503 and the memory 2501 described above and programs such as the OS and the application programs.

Summarization of the Embodiments Described Above is as Follows.

A search processing method according to the embodiment includes processing of (A) accepting entry of a character string (for example, character string of the step S41 in the embodiment), (B) identifying a first word (for example, word extracted in the step S45 in the embodiment) from inquiry data including data about inquiries (for example, data stored in the inquiry data storing unit 101 in the embodiment) based on the probability at which the first word appears next to the character string in the inquiry data, (C) extracting a plurality of inquiry collections each including one or a plurality of inquiries whose correct answer is the same question-and-answer data from the inquiry data, (D) identifying a second word (for example, word extracted in the step S47 in the embodiment) that appears in an inquiry collection different from an inquiry collection in which the first word appears among the plurality of inquiry collections based on the ratios between the probability of appearance of the first word in a respective one of the plurality of inquiry collections and the probability of appearance of the second word in the respective one of the plurality of inquiry collections, and (E) carrying out a search of a first data storing unit (for example, Q&A data storing unit 104 in the embodiment) that stores question-and-answer data based on the character string, the first word, and the second word.

It is difficult to understand the true intention of a user only from the entered character string. However, if the processing described above is executed, a search based on words identified from a wide variety of perspectives is carried out. Thus, it becomes possible to avoid extraction of the search result with biased perspectives and extract the correct question-and-answer data.

Furthermore, the search processing method may further include processing of (F) regarding each of words included in the plurality of inquiry collections, calculating the probability of appearance of the word in the respective one of the plurality of inquiry collections, and (G) regarding each of the plurality of inquiry collections, identifying a word whose probability of appearance in the inquiry collection is equal to or higher than a given value, and storing the word in a second data storing unit. Furthermore, in the processing of identifying the second word, (d1) the second word may be identified from the words stored in the second data storing unit based on the ratios between the probability of appearance of the first word in the respective one of the plurality of inquiry collections and the probability of appearance of the second word in the respective one of the plurality of inquiry collections.

It becomes possible to suppress selection of words whose correct question-and-answer data is the same. Furthermore, if the probability is calculated in advance, it becomes possible to rapidly carry out a search when the character string is entered.

Moreover, in the search processing method, (H) regarding each of word strings that appear in the inquiry data and include two words, the probability of appearance of the word string may be calculated, and the probability that is calculated may be stored in a third data storing unit. Furthermore, in the processing of identifying the first word, (b1) the first word may be identified based on the probability stored in the third data storing unit.

If the probability is calculated in advance, it becomes possible to rapidly carry out a search when the character string is entered.

In addition, the search processing method may further include processing of (I) identifying a third word that appears in an inquiry collection different from the inquiry collection in which the first word appears and the inquiry collection in which the second word appears among the plurality of inquiry collections based on the ratios between the probability of appearance of the first word and the second word in the respective one of the plurality of inquiry collections and the probability of appearance of the third word in the respective one of the plurality of inquiry collections. Furthermore, in the processing of carrying out the search, (e1) the search of the first data storing unit may be carried out based on the character string, the first word, the second word, and the third word.

It becomes possible to carry out a search based on a word obtained from a further different perspective.

Furthermore, in the processing of identifying the second word, (d2) the second word may be identified based further on the probability at which the second word appears next to the character string.

It becomes possible to identify the second word that is more proper.

Moreover, the search processing method may further include processing of (J) outputting a result of the search of the first data storing unit.

It becomes possible for the user or the like who has entered the character string to check the result of the search.

In addition, the first word may be a word having the highest probability of appearance next to the character string.

Furthermore, the second word may be a content word.

A program for causing a computer to execute the processing based on the above-described method may be created. This program is stored in a computer-readable storing medium or storing device such as a flexible disc, compact disc-read only memory (CD-ROM), magneto-optical disc, semiconductor memory, or hard disk. An intermediate processing result is temporarily stored in a storing device such as a main memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A computer-implemented method for creating and searching a database, the method comprising:
storing inquiry data within a database, the inquiry data including a plurality of questions and related answers, each of the questions and answers including one or more words;
dividing the inquiry data into sentences to generate sentence data;
segmenting the sentence data to obtain word string data;
identifying a plurality of content words within with the word string data, the plurality of content words including a first word and a second word;
counting a number of times each of the plurality of content words are included within the word string data;
calculating a first probability for each of the plurality of content words, the first probability indicating a probability of the first word being adjacent to the second word;
receiving an instruction including at least one word string;
selecting a first extended keyword from the database based on the first probability for each of the content words, the first extended keyword including a word string from the instruction and a first content word having a highest probability of being adjacent to the word string;
extracting a second extended keyword from the database based on the first probability for each of the content words, the second extended keyword having a second content word having a lower probability than the first content word of being adjacent to the word string;
searching the database based on a word string, first extended keyword and second extended keyword; and
outputting candidate questions or answers from the inquiry data as search results obtained from the database.

2. The computer-implemented method according to claim 1, wherein the second extended key word has a different meaning than the first content word.

3. The computer-implemented method according to claim 2, wherein the searching searches based on a search expression of (the word string) AND (first extended keyword OR second extended keyword).

4. The computer-implemented method according to claim 1, wherein storing the inquiry data includes
grouping the inquiry data into a plurality of different inquiry collections, each inquiry collection including one or a plurality of inquiries with a corresponding question or answer.

5. The computer-implemented method according to claim 4, wherein the first content word is included within a different inquiry collection than the second content word.

6. The computer-implemented method according to claim 2, wherein the first probability (P(w|u)) is calculated according to expression:
$$P ( w \vert u ) = \frac{cnt ( u , w )}{cnt ( w )}$$
w represent the first word, u represents the second word, cnt(w) represents a number of times the first word is included within word string data, cnt(u, w) represents a number of times the first word is adjacent to the second word in the word string data.

7. The computer-implemented method according to claim 6, wherein extracting the second extended keyword is based on expressions
$$arg {max}_{{w}_{i} ∈ V \backslash S} λ {sim}_{1} ( {w}_{i} , Q ) - ( 1 - λ ) {max}_{{q}_{j} ∈ S} {sim}_{2} ( {w}_{i} , {q}_{j} )$$
Q represent word strings (t1, t2, . . . ) generated from the instruction, V is a set of candidates for extended keywords, wᵢ is a candidate for an extended keyword included in V, S is a set of extended keywords, qⱼ is an extended keyword included in S, λ is a hyperparameter;
sim₁(wᵢ, Q) is represented as
sim₁(wᵢ,Q)=P(wᵢ|Q)=P(wᵢ|t₁,t₂, . . . ),
and represents a linkage of a content word with the word strings (t1, t2, . . . );
sim₂(wᵢ, qⱼ) is represented as
$${sim}_{2} ( {w}_{i} , {q}_{j} ) = {\{ {\sum }_{k} {P}_{k} ( {w}_{i} ) log \frac{{P}_{k} ( {w}_{i} )}{{P}_{k} ( {q}_{j} )} \}}^{- 1}$$
and is used as measure of difference of the meaning to an extended keyword previously selected.

8. A search processing device comprising:
a memory that stores inquiry data within a database, the inquiry data including a plurality of questions and related answers, each of the questions and answers including one or more words; and
a processor coupled to the memory; wherein
the inquiry data is divided into sentences to generate sentence data; wherein
the sentence data is segmented to obtain word string data; wherein
a plurality of content words is identified within with the word string data, the plurality of content words including a first word and a second word; and wherein
the processor is configured to:
receive an instruction from a user terminal, the instruction including at least one word string;
select a first extended keyword from the database based on a first probability for each of the content words, the first probability indicating a probability of the first word being adjacent to the second word, the first extended keyword including a word string from the instruction and a first content word having a highest probability of being adjacent to the word string;
extract a second extended keyword from the database based on the first probability for each of the content words, the second extended keyword having a second content word having a lower probability than the first content word of being adjacent to the word string;
search the database based on a word string, first extended keyword and second extended keyword; and
output candidate questions or answers from the inquiry data as search results obtained from the database.

9. The search processing device according to claim 8, wherein the second extended key word has a different meaning than the first content word.

10. The search processing device according to claim 9, wherein the processor searches based on a search expression of (the word string) AND (first extended keyword OR second extended keyword).

11. The search processing device according to claim 8, wherein the processor outputs the search results to the user terminal as a response to the received instruction.

12. A search processing device comprising:
a memory that stores inquiry data within a database, the inquiry data including a plurality of questions and related answers, each of the questions and answers including one or more words; and
a processor coupled to the memory, and the processor configured to:
divide the inquiry data into sentences to generate sentence data;
segment the sentence data to obtain word string data;
identify a plurality of content words within with the word string data, the plurality of content words including a first word and a second word;
count a number of times each of the plurality of content words are included within the word string data;
calculate a first probability for each of the plurality of content words, the first probability indicating a probability of the first word being adjacent to the second word; wherein
a first extended keyword and a second extended keyword are extracted from the database based on the first probability for each of the content words, the first extended keyword including a word string from the instruction and a first content word having a highest probability of being adjacent to the word string, the second extended keyword having a second content word having a lower probability than the first content word of being adjacent to the word string; and wherein
searching the database is performed based on a word string, first extended keyword and second extended keyword.

13. The search processing device according to claim 12, wherein the processor groups the inquiry data into a plurality of different inquiry collections, each inquiry collection including one or a plurality of inquiries with a corresponding question or answer.

14. The search processing device according to claim 13, wherein the first content word is included within a different inquiry collection than the second content word.

15. The search processing device according to claim 12, wherein the second extended key word has a different meaning than the first content word.

16. The search processing device according to claim 15, wherein the processor calculates the first probability (P(w|u)) according to expression:
$$P ( w \vert u ) = \frac{cnt ( u , w )}{cnt ( w )}$$
w represent the first word, u represents the second word, cnt(w) represents a number of times the first word is included within word string data, cnt(u, w) represents a number of times the first word is adjacent to the second word in the word string data.

17. The search processing device according to claim 16, wherein the processor extracts the second extended keyword based on expressions
$$arg {max}_{{w}_{i} ∈ V \backslash S} λ {sim}_{1} ( {w}_{i} , Q ) - ( 1 - λ ) {max}_{{q}_{j} ∈ S} {sim}_{2} ( {w}_{i} , {q}_{j} )$$
Q represent word strings (t1, t2, . . . ) generated from the instruction, V is a set of candidates for extended keywords, wᵢ is a candidate for an extended keyword included in V, S is a set of extended keywords, qⱼ is an extended keyword included in S, λ is a hyperparameter; sim₁(wᵢ, Q) is represented as
sim₁(wᵢ,Q)=P(wᵢ|Q)=P(wᵢ|t₁,t₂, . . . ),
and represents a linkage of a content word with the word strings (t1, t2, . . . );
sim₂(wᵢ, qⱼ) is represented as
$${sim}_{2} ( {w}_{i} , {q}_{j} ) = {\{ {\sum }_{k} {P}_{k} ( {w}_{i} ) log \frac{{P}_{k} ( {w}_{i} )}{{P}_{k} ( {q}_{j} )} \}}^{- 1}$$
and is used as measure of difference of the meaning to an extended keyword previously selected.

18. A non-transitory computer-readable storage medium storing a search processing program that causes a computer to execute a process, the process comprising:
accepting entry of a character string;
identifying a first word from inquiry data including data about inquiries based on a probability at which the first word appears next to the character string in the inquiry data;
extracting a plurality of inquiry collections each including one or a plurality of inquiries whose correct answer is the same question-and-answer data from the inquiry data;
identifying a second word that appears in an inquiry collection different from an inquiry collection in which the first word appears among the plurality of inquiry collections based on ratios between a probability of appearance of the first word in a respective one of the plurality of inquiry collections and a probability of appearance of the second word in the respective one of the plurality of inquiry collections; and
carrying out a search of a first data storing unit that stores question-and-answer data based on the character string, the first word, and the second word.
